(19) United States
(12) Patent Application Publication
(10) Pub. No.: US 2019/0143684 A1
(43) Pub. Date: May 16, 2019

(54) LIQUID JET HEAD AND LIQUID JET RECORDING DEVICE

(71) Applicant: SII Printek Inc., Chiba-shi (JP)

(72) Inventors: Shutaro YAMAMOTO, Chiba-shi (JP); Daichi NISHIKAWA, Chiba-shi (JP); Emiko OSAKA, Chiba-shi (JP)

(21) Appl. No.: 16/187,023

(22) Filed: Nov. 12, 2018

(30) Foreign Application Priority Data
Nov. 13, 2017 (JP) 2017-218100

(51) Int. Cl. B41J 2/14; B41J 2/045

(52) U.S. Cl. CPC B41J 2/1433; B41J 2/04505

(57) ABSTRACT

There are provided a liquid jet head and a liquid jet recording device capable of enhancing the reliability. A liquid jet head according to an embodiment of the disclosure is a liquid jet head adapted to jet a liquid including an actuator plate having a plurality of ejection grooves each filled with the liquid, and a nozzle plate having a plurality of nozzle holes individually communicated with the respective ejection grooves, formed so as to have a profile smaller than a profile of the actuator plate, and bonded to the actuator plate so as to cover the plurality of ejection grooves, wherein a predetermined mark with which a position of the nozzle plate with respect to the actuator plate is checked is formed in an area outside a part corresponding to an outer periphery of the nozzle plate on a bonding surface of the actuator plate with the nozzle plate.

### RELATED APPLICATIONS

This application claims priority under 35 U.S.C. § 119 to Japanese Patent Application No. 2017-218100 filed on Nov. 13, 2017, the entire content of which is hereby incorporated by reference.

### BACKGROUND OF THE INVENTION

### 1. Field of the Invention

The present disclosure relates to a liquid jet head and a liquid jet recording device.

### 2. Description of the Related Art

As one of liquid jet recording devices, there is provided an inkjet type recording device for ejecting (jetting) ink (liquid) on a recording target medium such as recording paper to perform recording of images, characters, and so on (see, e.g., JP-A-2017-109386).

In the liquid jet recording device of this type, it is arranged that the ink is supplied from an ink tank to an inkjet head (a liquid jet head), and then the ink is ejected from nozzle holes of the inkjet head toward the recording target medium to thereby perform recording of the images, the characters, and so on.

In such a liquid jet head and so on, in general, it is required to enhance the reliability. It is desirable to provide a liquid jet head and a liquid jet recording device capable of enhancing the reliability.

### SUMMARY OF THE INVENTION

A liquid jet head according to an embodiment of the disclosure is a liquid jet head adapted to jet a liquid including an actuator plate having a plurality of ejection grooves each filled with the liquid, and a nozzle plate having a plurality of nozzle holes individually communicated with the respective ejection grooves, formed so as to have a profile smaller than a profile of the actuator plate, and bonded to the actuator plate so as to cover the plurality of ejection grooves, wherein a predetermined mark with which a position of the nozzle plate with respect to the actuator plate is checked is formed in an area outside a part corresponding to an outer periphery of the nozzle plate on a bonding surface of the actuator plate with the nozzle plate.

A liquid jet recording device according to an embodiment of the disclosure is equipped with the liquid jet head according to an embodiment of the disclosure, and a containing section adapted to contain the liquid.

According to the liquid jet head and the liquid jet recording device related to an embodiment of the disclosure, it becomes possible to enhance the reliability.

### BRIEF DESCRIPTION OF THE DRAWINGS

FIG. 1 is a schematic perspective view showing a schematic configuration example of a liquid jet recording device according to one embodiment of the disclosure.

FIG. 2 is a schematic bottom view showing a configuration example of a substantial part of the inkjet head shown in FIG. 1.

FIG. 3 is a schematic diagram showing a cross-sectional configuration example along the line in the inkjet head shown in FIG. 2.

FIG. 4 is a schematic diagram showing a cross-sectional configuration example of the inkjet head along the line IV-IV shown in FIG. 2.

FIG. 5 is a schematic diagram showing a cross-sectional configuration example of the inkjet head along the line V-V shown in FIG. 2.

FIG. 6 is a top view showing a configuration example of a substantial part of an actuator plate in the head chip shown in FIG. 2.

FIG. 7 is a bottom view showing a configuration example of a substantial part of a cover plate in the head chip shown in FIG. 2.

FIG. 8 is an explanatory diagram regarding a formation position of a predetermined mark in the actuator plate shown in FIG. 2.

FIG. 9 is an exploded perspective view showing a configuration example of a substantial part of the inkjet head shown in FIG. 1.

FIG. 10 is a schematic bottom view showing a configuration example of a substantial part of an inkjet head related to a comparative example.

FIG. 11 is a schematic bottom view showing a configuration example of a substantial part of an inkjet head related to Modified Example 1.

FIG. 12 is an exploded perspective view showing a configuration example of a substantial part of an inkjet head related to Modified Example 2.

FIG. 13 is a schematic bottom view showing a configuration example of a substantial part of an inkjet head related to Modified Example 3.

### DETAILED DESCRIPTION OF THE PREFERRED EMBODIMENTS

An embodiment of the present disclosure will hereinafter be described in detail with reference to the drawings. It should be noted that the description will be presented in the following order.

1. Embodiment (an example in which a predetermined mark is formed in an area outside a part corresponding to an outer periphery of a nozzle plate in an actuator plate)

2. Modified Examples

Modified Example 1 (an example in which the predetermined mark is formed of a part of an alignment mark)

Modified Example 2 (a modified example of a cover member)

Modified Example 3 (a formation example of the predetermined mark in the case in which a nozzle plate is divided)

3. Other Modified Examples

### 1. EMBODIMENT

[Overall Configuration of Printer 1]

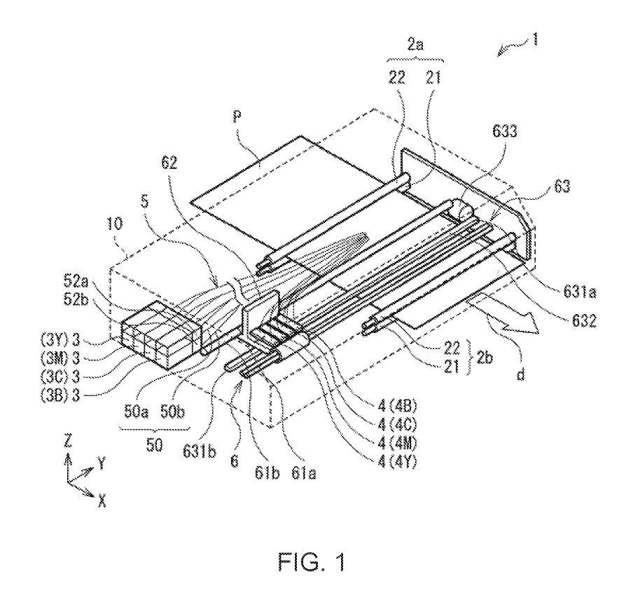

FIG. 1 is a perspective view schematically showing a schematic configuration example of a printer 1 as a liquid jet recording device according to one embodiment of the present disclosure. The printer 1 is an inkjet printer for performing recording (printing) of images, characters, and so on, on recording paper P as a recording target medium using ink 9 described later.

As shown in FIG. 1, the printer 1 is provided with a pair of carrying mechanisms 2a, 2b, ink tanks 3, inkjet heads 4, a circulation mechanism 5, and a scanning mechanism 6. These members are housed in a housing 10 having a predetermined shape. It should be noted that the scale size of each member is accordingly altered so that the member is shown large enough to recognize in the drawings used in the description of the specification.

Here, the printer 1 corresponds to a specific example of the “liquid jet recording device” in the present disclosure, and the inkjet heads 4 (the inkjet heads 4Y, 4M, 4C, and 4B described later) each correspond to a specific example of a “liquid jet head” in the present disclosure. Further, the ink 9 corresponds to a specific example of the “liquid” in the present disclosure.

The carrying mechanisms 2a, 2b are each a mechanism for carrying the recording paper P along the carrying direction d (an X-axis direction) as shown in FIG. 1. These carrying mechanisms 2a, 2b each have a grit roller 21, a pinch roller 22 and a drive mechanism (not shown). The grit roller 21 and the pinch roller 22 are each disposed so as to extend along a Y-axis direction (the width direction of the recording paper P). The drive mechanism is a mechanism for rotating (rotating in a Z-X plane) the grit roller 21 around an axis, and is constituted by, for example, a motor.

(Ink Tanks 3)

The ink tanks 3 are each a tank for containing the ink 9 inside. As the ink tanks 3, there are disposed 4 types of tanks for individually containing 4 colors of ink 9, namely yellow (Y), magenta (M), cyan (C), and black (B), in this example as shown in FIG. 1. Specifically, there are disposed the ink tank 3Y for containing the yellow ink 9, the ink tank 3M for containing the magenta ink 9, the ink tank 3C for containing the cyan ink 9, and the ink tank 3B for containing the black ink 9. These ink tanks 3Y, 3M, 3C, and 3B are arranged side by side along the X-axis direction inside the housing 10.

It should be noted that the ink tanks 3Y, 3M, 3C, and 3B have the same configuration except the color of the ink 9 contained, and are therefore collectively referred to as ink tanks 3 in the following description. Further, the ink tanks 3 (3Y, 3M, 3C, and 3B) each correspond to a specific example of a “containing section” in the present disclosure.

(Inkjet Heads 4)

The inkjet heads 4 are each a head for jetting (ejecting) the ink 9 having a droplet shape from a plurality of nozzles (nozzle holes H1, H2) described later to the recording paper P to thereby perform recording of images, characters, and so on. As the inkjet heads 4, there are also disposed 4 types of heads for individually jetting the 4 colors of ink 9 respectively contained by the ink tanks 3Y, 3M, 3C, and 3B described above in this example as shown in FIG. 1. Specifically, there are disposed the inkjet head 4Y for jetting the yellow ink 9, the inkjet head 4M for jetting the magenta ink 9, the inkjet head 4C for jetting the cyan ink 9, and the inkjet head 4B for jetting the black ink 9. These inkjet heads 4Y, 4M, 4C, and 4B are arranged side by side along the Y-axis direction inside the housing 10.

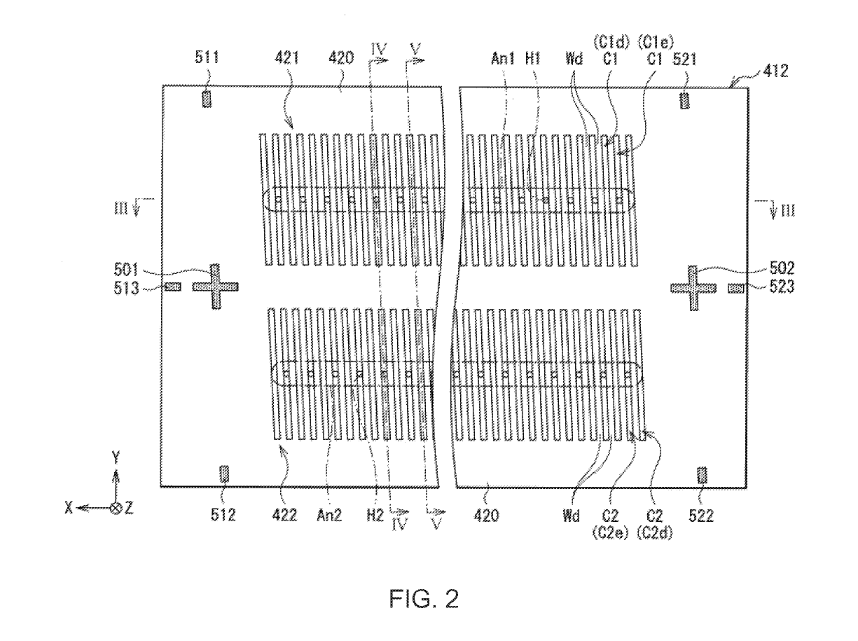

It should be noted that the inkjet heads 4Y, 4M, 4C, and 4B have the same configuration except the color of the ink 9 used, and are therefore collectively referred to as inkjet heads 4 in the following description. Further, the detailed configuration of the inkjet heads 4 will be described later (FIG. 2 through FIG. 9).

(Circulation Mechanism 5)

The circulation mechanism 5 is a mechanism for circulating the ink 9 between the inside of the ink tanks 3 and the inside of the inkjet heads 4. The circulation mechanism 5 is configured including, for example, circulation channels 50 as flow channels for circulating the ink 9, and pairs of liquid feeding pumps 52a, 52b.

As shown in FIG. 1, the circulation channels 50 each have a flow channel 50a as a part extending from the ink tank 3 to reach the inkjet head 4 via the liquid feeding pump 52a, and a flow channel 50b as a part extending from the inkjet head 4 to reach the ink tank 3 via the liquid feeding pump 52b. In other words, the flow channel 50a is a flow channel through which the ink 9 flows from the ink tank 3 toward the inkjet head 4. Further, the flow channel 50b is a flow channel through which the ink 9 flows from the inkjet head 4 toward the ink tank 3. It should be noted that these flow channels 50a, 50b (supply tubes of the ink 9) are each formed of a flexible hose having flexibility.

(Scanning Mechanism 6)

The scanning mechanism 6 is a mechanism for making the inkjet heads 4 perform a scanning operation along the width direction (the Y-axis direction) of the recording paper P. As shown in FIG. 1, the scanning mechanism 6 has a pair of guide rails 61a, 61b disposed so as to extend along the Y-axis direction, a carriage 62 movably supported by these guide rails 61a, 61b, and a drive mechanism 63 for moving the carriage 62 along the Y-axis direction. Further, the drive mechanism 63 is provided with a pair of pulleys 631a, 631b disposed between the pair of guide rails 61a, 61b, an endless belt 632 wound between the pair of pulleys 631a, 631b, and a drive motor 633 for rotationally driving the pulley 631a.

The pulleys 631a, 631b are respectively disposed in areas corresponding to the vicinities of both ends in each of the guide rails 61a, 61b. To the endless belt 632, there is connected the carriage 62. On the carriage 62, there are disposed the four types of inkjet heads 4Y, 4M, 4C, and 4B arranged side by side along the Y-axis direction.

It should be noted that it is arranged that a moving mechanism for moving the inkjet heads 4 relatively to the recording paper P is constituted by such a scanning mechanism 6 and the carrying mechanisms 2a, 2b described above.

[Detailed Configuration of Inkjet Heads 4]

Then, the detailed configuration example of the inkjet heads 4 (head chips 41) will be described with reference to FIG. 2 through FIG. 9, in addition to FIG. 1.

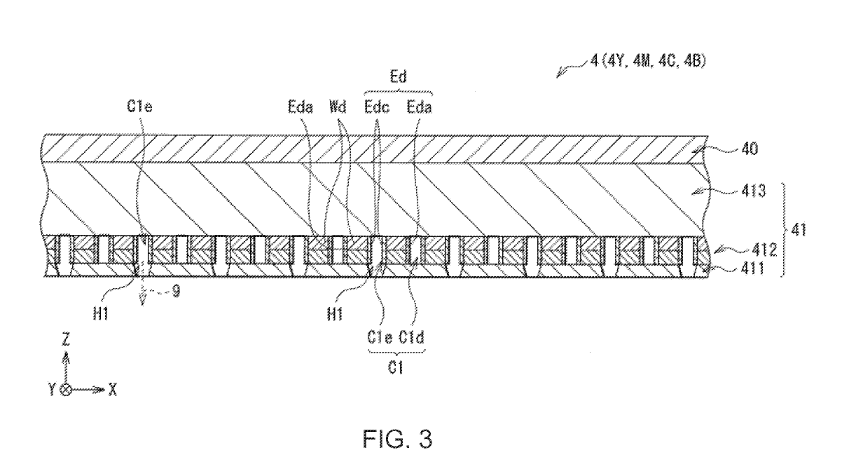

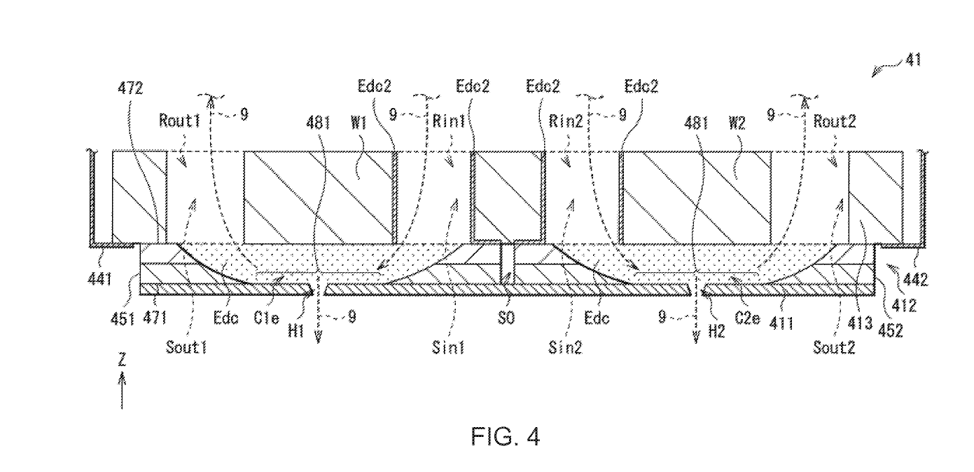

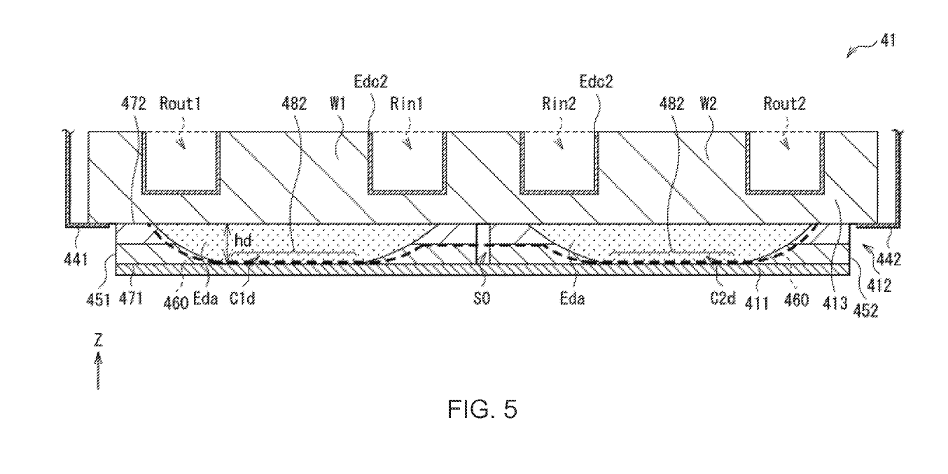

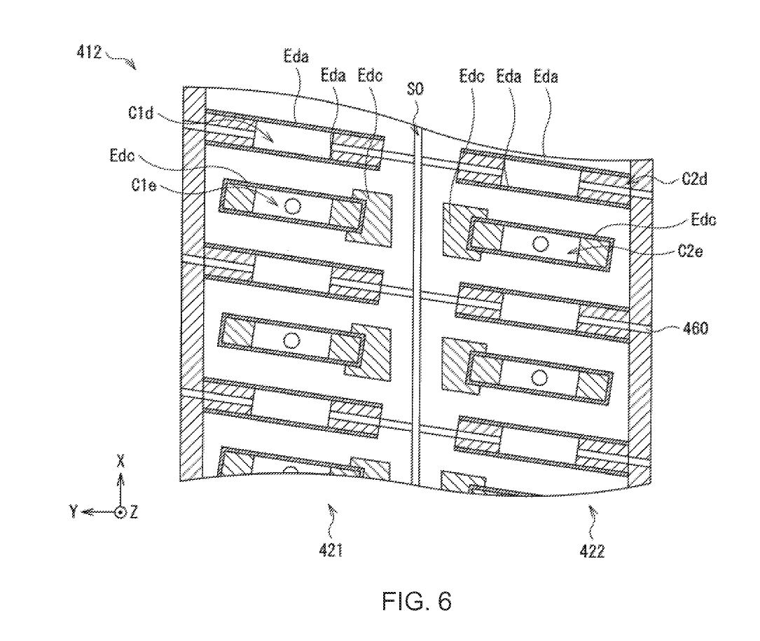

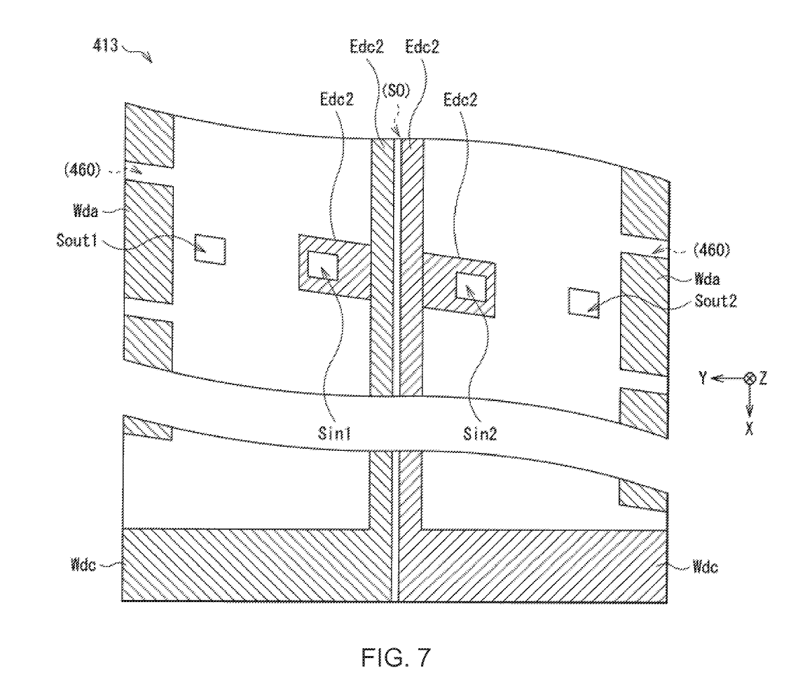

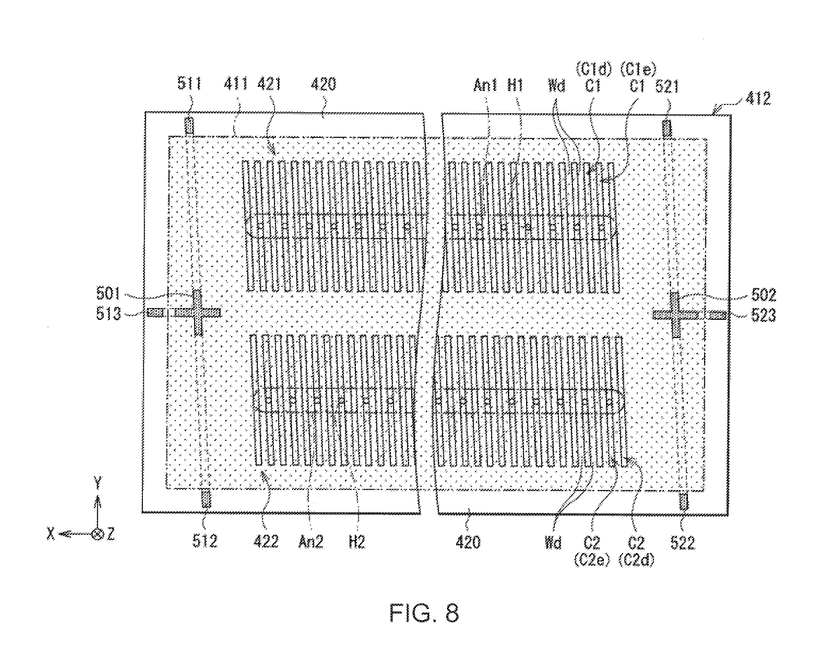

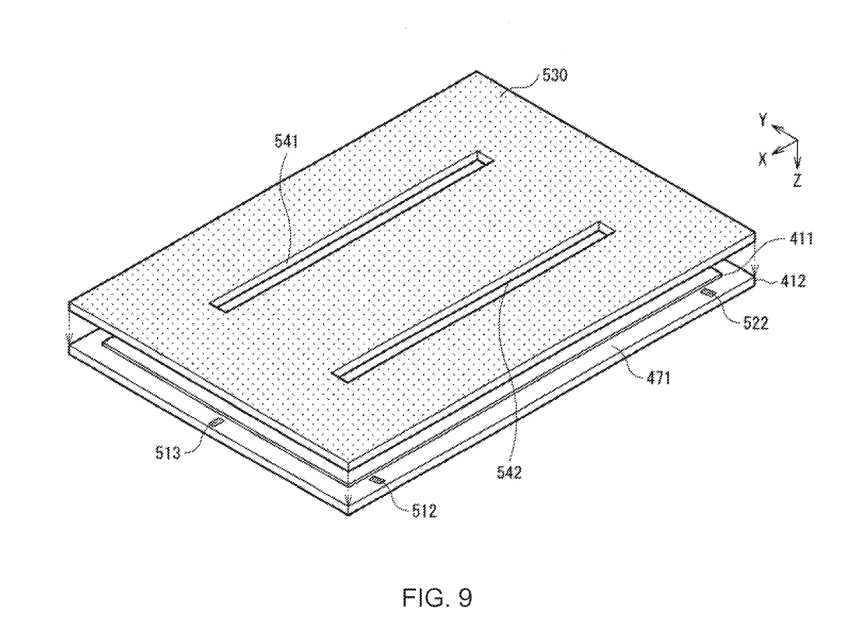

FIG. 2 is a diagram schematically showing a bottom view (an X-Y bottom view) of a configuration example of a substantial part of the inkjet head 4 in the state in which a nozzle plate 411 (described later) is removed. FIG. 3 is a diagram schematically showing a cross-sectional configuration example (a Z-X cross-sectional configuration example) of the inkjet head 4 along the line shown in FIG. 2. Similarly, FIG. 4 is a diagram schematically showing a cross-sectional configuration example of the inkjet head 4 along the line IV-IV shown in FIG. 2, and corresponds to a cross-sectional configuration example of a vicinity of ejection channels C1e, C2e (ejection grooves) in the head chip 41 described later. Further, FIG. 5 is a diagram schematically showing a cross-sectional configuration example of the inkjet head 4 along the line V-V shown in FIG. 2, and corresponds to a cross-sectional configuration example of a vicinity of dummy channels C1d, C2d (non-ejection grooves) in the head chip 41 described later. FIG. 6 is a top view schematically showing a configuration example of a substantial part of an actuator plate 412 in the head chip 41 described later. FIG. 7 is a bottom view schematically showing a configuration example of a substantial part of a cover plate 413 in the head chip 41 described later. FIG. 8 is an explanatory diagram regarding a formation position of a predetermined mark described later in the actuator plate shown in FIG. 2. FIG. 9 is an exploded perspective view showing a configuration example of a substantial part of the inkjet head 4 shown in FIG. 1.

The inkjet heads 4 according to the present embodiment are each an inkjet head of a so-called side-shoot type for ejecting the ink 9 from a central part in an extending direction (an oblique direction described later) of the ejection channels C1e, C2e out of a plurality of channels (a plurality of channels C1 and a plurality of channels C2) in the head chip 41 described later. Further, the inkjet heads 4 are each an inkjet head of a circulation type which uses the circulation mechanism 5 (the circulation channel 50) described above to thereby use the ink 9 while circulated between the inkjet head 4 and the ink tank 3.

As shown in FIG. 3, the inkjet heads 4 are each provided with the head chip 41 and a flow channel plate 40. Further, the inkjet heads 4 are each provided with a circuit board (not shown) and flexible printed circuit boards (FPC) 441, 442 (see FIG. 4 and FIG. 5) as a control mechanism (a mechanism for controlling the operation of the head chip 41). It should be noted that it is also possible to adopt a structure (chip on FPC (COF)) in which the control mechanism (e.g., a driver IC) is mounted on the FPC.

The circuit board is a board for mounting a drive circuit (an electric circuit) for driving the head chip 41. The flexible printed circuit boards 441, 442 are each a board for electrically connecting the drive circuit on the circuit board and drive electrodes Ed described later in the head chip 41 to each other. It should be noted that it is arranged that such flexible printed circuit boards 441, 442 are each provided with a plurality of extraction electrodes described later as printed wiring.

As shown in FIG. 3, the head chip 41 is a member for jetting the ink 9 along the Z-axis direction, and is configured using a variety of types of plates. Specifically, as shown in FIG. 3, the head chip 41 is mainly provided with a nozzle plate (a jet hole plate) 411, an actuator plate 412 and a cover plate 413. The nozzle plate 411, the actuator plate 412, the cover plate 413, and the flow channel plate 40 described above are bonded to each other using, for example, an adhesive, and are stacked on one another in this order along the Z-axis direction. It should be noted that the description will hereinafter be presented with the flow channel plate 40 side (the cover plate 413 side) along the Z-axis direction referred to as an upper side, and the nozzle plate 411 side referred to as a lower side.

(Nozzle Plate 411)

The nozzle plate 411 is formed of a metal film material made of stainless steel or the like, and has a thickness of, for example, about 50 μm. It should be noted that the nozzle plate 411 can also be formed of a film material made of polyimide or the like. Further, the material of the nozzle plate 411 can also be glass or silicon. As shown in FIG. 3 and FIG. 4, the nozzle plate 411 is bonded to the lower surface (a bonding surface 471) of the actuator plate 412. Further, as shown in FIG. 2, the nozzle plate 411 is provided with two nozzle columns (nozzle columns An1, An2) each extending along the X-axis direction. These nozzle columns An1, An2 are arranged along the Y-axis direction with a predetermined distance. As described above, the inkjet head 4 (the head chip 41) of the present embodiment is formed as a tow-column type inkjet head (head chip).

The nozzle column An1 has a plurality of nozzle holes H1 formed in alignment with each other at predetermined intervals along the X-axis direction. These nozzle holes H1 each penetrate the nozzle plate 411 along the thickness direction of the nozzle plate 411 (the Z-axis direction), and are communicated with the respective ejection channels C1e in the actuator plate 412 described later as shown in, for example, FIG. 3 and FIG. 4. Specifically, as shown in FIG. 2, each of the nozzle holes H1 is formed so as to be located in a central part along the extending direction (an oblique direction described later) of the ejection channels C1e. Further, the formation pitch along the X-axis direction in the nozzle holes H1 is arranged to be equal (to have an equal pitch) to the formation pitch along the X-axis direction in the ejection channels C1e. Although the details will be described later, it is arranged that the ink 9 supplied from the inside of the ejection channel C1e is ejected (jetted) from each of the nozzle holes H1 in such a nozzle column An1.

The nozzle column An2 similarly has a plurality of nozzle holes H2 formed in alignment with each other at predetermined intervals along the X-axis direction. These nozzle holes H2 each penetrate the nozzle plate 411 along the thickness direction of the nozzle plate 411, and are individually communicated with the respective ejection channels C2e in the actuator plate 412 described later. Specifically, as shown in FIG. 2, each of the nozzle holes H2 is formed so as to be located in a central part along the extending direction (an oblique direction described later) of the ejection channels C2e. Further, the formation pitch along the X-axis direction in the nozzle holes H2 is arranged to be equal to the formation pitch along the X-axis direction in the ejection channels C2e. Although the details will be described later, it is arranged that the ink 9 supplied from the inside of the ejection channel C2e is also ejected from each of the nozzle holes H2 in such a nozzle column An2.

Further, as shown in FIG. 2, the nozzle holes H1 in the nozzle column An1 and the nozzle holes H2 in the nozzle column An2 are arranged in a staggered manner along the X-axis direction. Therefore, in each of the inkjet heads 4 according to the present embodiment, the nozzle holes H1 in the nozzle column An1 and the nozzle holes H2 in the nozzle column An2 are arranged in a zigzag manner. It should be noted that such nozzle holes H1, H2 each have a tapered through hole gradually decreasing in diameter toward the lower side.

(Actuator Plate 412)

The actuator plate 412 is a plate formed of a piezoelectric material such as lead zirconate titanate (PZT). As shown in FIG. 3, the actuator plate 412 is formed by stacking two piezoelectric substrates different in polarization direction from each other on one another along the thickness direction (the Z-axis direction) (a so-called chevron type). It should be noted that the configuration of the actuator plate 412 is not limited to the chevron type. Specifically, it is also possible to form the actuator plate 412 with, for example, a single (unique) piezoelectric substrate having the polarization direction set one direction along the thickness direction (the Z-axis direction) (a so-called cantilever type).

Further, as shown in FIG. 2, the actuator plate 412 is provided with two channel columns (channel columns 421, 422) each extending along the X-axis direction. These channel columns 421, 422 are arranged along the Y-axis direction with a predetermined distance.

In such an actuator plate 412, as shown in FIG. 2, an ejection area (jetting area) of the ink 9 is disposed in a central part (the formation areas of the channel columns 421, 422) along the X-axis direction. On the other hand, in the actuator plate 412, a non-ejection area (non-jetting area) of the ink 9 is disposed in each of the both end parts (non-formation areas of the channel columns 421, 422) along the X-axis direction. The non-ejection areas are located on the outer side along the X-axis direction with respect to the ejection area described above. It should be noted that the both end parts along the Y-axis direction in the actuator plate 412 each constitute a tail part 420 as shown in FIG. 2.

As shown in FIG. 2 and FIG. 3, the channel column 421 described above has the plurality of channels C1. As shown in FIG. 2, these channels C1 extend along an oblique direction forming a predetermined angle (an acute angle) with the Y-axis direction inside the actuator plate 412. Further, as shown in FIG. 2, these channels C1 are arranged side by side so as to be parallel to each other at predetermined intervals along the X-axis direction. Each of the channels C1 is partitioned with drive walls Wd formed of a piezoelectric body (the actuator plate 412), and forms a groove section having a recessed shape in a cross-sectional view (see FIG. 3).

As shown in FIG. 2, the channel column 422 similarly has the plurality of channels C2 extending along the oblique direction described above. As shown in FIG. 2, these channels C2 are arranged side by side so as to be parallel to each other at predetermined intervals along the X-axis direction. Each of the channels C2 is also partitioned with drive walls Wd described above, and forms a groove section having a recessed shape in a cross-sectional view.

Here, as shown in FIG. 2 through FIG. 5, in each of the channels C1, there exist the ejection channel C1e (the ejection groove) for ejecting the ink 9, and the dummy channel C1d (the non-ejection groove) not ejecting the ink 9. As shown in FIG. 2 and FIG. 3, in the channel column 421, the ejection channels Cle and the dummy channels C1d are alternately arranged along the X-axis direction. Each of the ejection channels C1e is communicated with the nozzle hole H1 in the nozzle plate 411 on the one hand, but each of the dummy channels C1d is not communicated with the nozzle hole H1, and is covered with the upper surface of the cover plate 411 from below on the other hand (see FIG. 3 through FIG. 5).

Similarly, as shown in FIG. 2, FIG. 4 and FIG. 5, in each of the channels C2, there exist the ejection channel C2e (the ejection groove) for ejecting the ink 9, and the dummy channel C2d (the non-ejection groove) not ejecting the ink 9. As shown in FIG. 2, in the channel column 422, the ejection channels C2e and the dummy channels C2d are alternately arranged along the X-axis direction. Each of the ejection channels C2e is communicated with the nozzle hole H2 in the nozzle plate 411 on the one hand, but each of the dummy channels C2d is not communicated with the nozzle hole H2, and is covered with the upper surface of the cover plate 411 from below on the other hand (see FIG. 4 and FIG. 5).

It should be noted that such ejection channels C1e, C2e each correspond to a specific example of the “ejection groove” in the present disclosure.

Further, as indicated by the line IV-IV in FIG. 2, the ejection channels C1e in the channel column 421 and the ejection channel C2e in the channel column 422 are disposed in alignment with each other (see FIG. 4) along the extending direction (the oblique direction described above) of these ejection channels C1e, C2e. Similarly, as indicated by the line V-V in FIG. 2, the dummy channels C1d in the channel column 421 and the dummy channel C2d in the channel column 422 are disposed in alignment with each other (see FIG. 5) along the extending direction (the oblique direction described above) of these dummy channels C1d, C2d.

Here, as shown in FIG. 3, the drive electrode Ed extending along the oblique direction described above is disposed on each of the inside surfaces opposed to each other in the drive walls Wd described above. As the drive electrodes Ed, there exist common electrodes Edc disposed on the inner side surfaces facing the ejection channels C1e, C2e, and individual electrodes (active electrodes) Eda disposed on the inner side surfaces facing the dummy channels C1d, C2d. It should be noted that such drive electrodes Ed (the common electrodes Edc and the active electrodes Eda) are each formed in the entire area in the depth direction (the Z-axis direction) on the inner side surface of the drive wall Wd as shown in FIG. 3.

The pair of common electrodes Edc opposed to each other in the same ejection channel C1e (or the same ejection channel C2e) are electrically connected to each other (see FIG. 6). Further, the pair of individual electrodes Eda opposed to each other in the same dummy channel C1d (or the same dummy channel C2d) are electrically separated from each other by an electrode dividing groove 460 (see FIG. 5) as described later. In contrast, the pair of individual electrodes Eda opposed to each other via the ejection channel C1e (or the ejection channel C2e) are electrically connected to each other in an individual terminal (an individual interconnection Wda) provided to the cover plate 413 described later (see FIG. 7).

Here, in the tail parts 420 described above, there are respectively mounted the flexible printed circuit boards 441, 442 (see FIG. 4 and FIG. 5) described above for electrically connecting the drive electrodes Ed and the circuit board described above to each other. The interconnection patterns (not shown) provided to these flexible printed circuit boards 441, 442 are electrically connected to the common interconnections Wdc and the individual interconnections Wda (see FIG. 7) provided to the cover plate 413 described above. Thus, it is arranged that the drive voltage is applied to each of the drive electrodes Ed from the drive circuit on the circuit board described above via these flexible printed circuit boards 441, 442.

The actuator plate 412 has the groove section S0 extending in the X-axis direction (see FIG. 6). The groove section S0 is formed between the ejection channel C1e and the ejection channel C2e, and between the dummy channel C2d and the dummy channel C2d (see FIG. 4 through FIG. 6).

In the head chip 41, the common electrodes Edc in the plurality of ejection channels C1e are electrically connected to each other in the vicinity (on the bottom surface of the cover plate 413) of the groove section S0 or the side surfaces of the entrance side common ink chamber Rin1, and are extracted as a common electrode Edc2. The common electrode Edc2 is extracted from the vicinity of the groove section S0 to the inside of the entrance side common ink chamber Rin1.

Similarly, in the head chip 41, the common electrodes Edc in the plurality of ejection channels C2e are electrically connected to each other in the vicinity (on the bottom surface of the cover plate 413) of the groove section S0 described above or the side surfaces of the entrance side common ink chamber Rin2, and are extracted as the common electrode Edc2. The common electrode Edc2 is extracted from the vicinity of the groove section S0 to the inside of the entrance side common ink chamber Rin2.

The actuator plate 412 has the bonding surface 471 with the nozzle plate 411 and a bonding surface 472 with the cover plate 413 (see FIG. 4 and FIG. 5).

The ejection channels C1e, C2e partially open in the bonding surface 471 of the actuator plate 412 with the nozzle plate 411 to form openings 481 (see FIG. 4). In each of the ejection channels C1e, C2e, the opening 481 is formed at roughly the center in the extending direction of the ejection channels C1e, C2e. In the bonding surface 471 of the actuator plate 412 with the nozzle plate 411, in the extending direction of the ejection channels C1e, C2e, a part of the ejection channel C1e, C2e is blocked by the bottom part of the ejection channel C1e, C2e, and at the same time, the other part of the ejection channel C1e, C2e partially opens.

The dummy channel C1d, C2d partially opens in the bonding surface 471 of the actuator plate 412 with the nozzle plate 411 to form an opening 482 (see FIG. 5). In each of the dummy channels C1d, C2d, the opening 482 is formed at roughly the center in the extending direction of the dummy channels C2d, C2d. In the bonding surface 471 of the actuator plate 412 with the nozzle plate 411, in the extending direction of the dummy channels C1d, C2d, a part of the dummy channel C1d, C2d is blocked by the bottom part of the dummy channel C1d, C2d, and at the same time, the other part of the dummy channel C1e, C2e partially opens.

It should be noted that as shown in FIG. 4, the ejection channels C1e, C2e each have arc-like side surfaces with which the cross-sectional area of each of the ejection channels C1e, C2e gradually decreases in a direction from the cover plate 413 side (upper side) toward the nozzle plate 411 side (lower side). It is arranged that the arc-like side surfaces of such ejection channels C1e, C2e are each formed by, for example, cutting work using a dicer.

Similarly, as shown in FIG. 5, the dummy channels C1d, C2d each have arc-like side surfaces with which the cross-sectional area of each of the dummy channels C1d, C2d gradually decreases in a direction from the cover plate 413 side (upper side) toward the nozzle plate 411 side (lower side). Thus, in the extending direction of the dummy channels C1d, C2d, the groove depth hd in each of the dummy channels C1d, C2d is deep at the center, and becomes shallower in a direction toward the side surface. It is arranged that the arc-like side surfaces of such dummy channels C1d, C2d are each formed by, for example, cutting work using a dicer.

In the extending direction of the ejection channels C1e, C2e, and the extending direction of the dummy channels C1d, C2d, the actuator plate 412 has a first end surface 451, and a second end surface 452 facing to an opposite side to the first end surface 451 (opposed to the first end surface 451) as predetermined end surfaces.

It should be noted that as a method of forming the drive electrodes Ed (the common electrodes Edc and the individual electrodes Eda) in the actuator plate 412, there can be cited a method of forming the drive electrodes Ed by plating, a method of forming the drive electrodes Ed by vapor deposition, and a method of forming the drive electrodes Ed by sputtering. In the inkjet heads 4 according to the present embodiment, as described above, the drive electrodes Ed are each formed in the entire area in the depth direction (the Z-axis direction) on the inner side surface of the drive wall Wd as shown in FIG. 3. In this case, the drive electrodes Ed are formed by, for example, plating. In this case, there is a possibility that a pair of individual electrodes Eda opposed to each other in the same dummy channel C1d (or the same dummy channel C2d) extend up to the bottom surface side in the channel, and the pair of individual electrodes Eda are electrically connected to each other. Therefore, it can be necessary to electrically separate the pair of individual electrodes Eda, which are opposed to each other in the same dummy channel C1d (or the same dummy channel C2d), from each other in the bottom surface side inside the channel by processing such as an electrode dividing groove 460 (see FIG. 5). The electrode dividing groove 460 is provided to the bottom surface of each of the dummy channels C1d, C2d so as to electrically separate the pair of individual electrodes Eda respectively into one side surface side and the other side surface side in each of the dummy channels C1d, C2d.

In contrast, as a modified example with respect to the inkjet heads 4 according to the present embodiment, it is also possible to adopt a configuration in which each of the drive electrodes Ed is not formed beyond an intermediate position in the depth direction on the inner side surface of the drive wall Wd. In this case, the drive electrodes Ed are formed by, for example, oblique evaporation. In this case, the actuator plate 412 can also be of the cantilever type constituted by a single piezoelectric substrate. In this case, depending on the structure, the pair of individual electrodes Eda opposed to each other in the same dummy channel C1d (or the same dummy channel C2d) are not necessarily electrically connected to each other. Therefore, the electrode separation by the additional processing is not necessary in some cases. Therefore, the electrode dividing groove 460 is not necessarily required to be formed.

In the actuator plate 412, on the bonding surface 471 with the nozzle plate 411, there are formed alignment marks 501, 502 and predetermined marks (first through third position checking marks 511, 512, 513, and the other first through third position checking marks 521, 522, 523) as shown in FIG. 2. The details of a configuration of formation positions and so on of the alignment marks 501, 502 and the predetermined marks will be described later in detail with reference to FIG. 8 and FIG. 9.

(Cover Plate 413)

As shown in FIG. 2 through FIG. 5, the cover plate 413 is disposed so as to close the channels C1, C2 (the channel columns 421, 422) in the actuator plate 412. Specifically, the cover plate 413 is bonded to the upper surface (the bonding surface 472) of the actuator plate 412, and is provided with a plate-like structure.

As shown in FIG. 5, the cover plate 413 is provided with a pair of entrance side common ink chambers Rin1, Rin2 and a pair of exit side common ink chambers Rout1, Rout2. The entrance side common ink chambers Rin1, Rin2 and the exit side common ink chambers Rout1, Rout2 each extend along the X-axis direction, and are arranged side by side so as to be parallel to each other at predetermined intervals. Further, the entrance side common ink chamber Rin1 and the exit side common ink chamber Rout1 are each formed in an area corresponding to the channel column 421 (the plurality of channels C1) in the actuator plate 412. Meanwhile, the entrance side common ink chamber Rin2 and the exit side common ink chamber Rout2 are each formed in an area corresponding to the channel column 422 (the plurality of channels C2) in the actuator plate 412.

The entrance side common ink chamber Rin1 is formed in the vicinity of an inner end part along the Y-axis direction in the channels C1, and forms a groove section having a recessed shape (see FIG. 5). In areas corresponding respectively to the ejection channels C1e in the entrance side common ink chamber Rin1, there are respectively formed supply slits Sin1 penetrating the cover plate 413 along the thickness direction (the Z-axis direction) of the cover plate 413 (see FIG. 4). Similarly, the entrance side common ink chamber Rin2 is formed in the vicinity of an inner end part along the Y-axis direction in the channels C2, and forms a groove section having a recessed shape (see FIG. 5). In areas corresponding respectively to the ejection channels C2e in the entrance side common ink chamber Rin2, there are respectively formed supply slits Sin2 penetrating the cover plate 413 along the thickness direction of the cover plate 413 (see FIG. 4).

The exit side common ink chamber Rout1 is formed in the vicinity of an outer end part along the Y-axis direction in the channels C1, and forms a groove section having a recessed shape (see FIG. 5). In areas corresponding respectively to the ejection channels C1e in the exit side common ink chamber Rout1, there are respectively formed discharge slits Sout1 penetrating the cover plate 413 along the thickness direction of the cover plate 413 (see FIG. 4). Similarly, the exit side common ink chamber Rout2 is formed in the vicinity of an outer end part along the Y-axis direction in the channels C2, and forms a groove section having a recessed shape (see FIG. 5). In areas corresponding respectively to the ejection channels C2e in the exit side common ink chamber Rout2, there are also respectively formed discharge slits Sout2 penetrating the cover plate 413 along the thickness direction of the cover plate 413 (see FIG. 4).

In such a manner, the entrance side common ink chamber Rin1 and the exit side common ink chamber Rout1 are communicated with each of the ejection channels C1e via the supply slit Sin1 and the discharge slit Sout1 on the one hand, but are not communicated with each of the dummy channels C1d on the other hand (see FIG. 4 and FIG. 5). In other words, it is arranged that each of the dummy channels C1d is closed by a bottom part of the entrance side common ink chamber Rin1 and a bottom part of the exit side common ink chamber Rout1 (see FIG. 5).

Similarly, the entrance side common ink chamber Rin2 and the exit side common ink chamber Rout2 are communicated with each of the ejection channels C2e via the supply slit Sin2 and the discharge slit Sout2 on the one hand, but are not communicated with each of the dummy channels C2d on the other hand (see FIG. 4 and FIG. 5). In other words, it is arranged that each of the dummy channels C2d is closed by a bottom part of the entrance side common ink chamber Rin2 and a bottom part of the exit side common ink chamber Rout2 (see FIG. 5).

(Flow Channel Plate 40)

As shown in FIG. 3, the flow channel plate 40 is disposed on the upper surface of the cover plate 413, and has a predetermined flow channel (not shown) through which the ink 9 flows. Further, to the flow channel in such a flow channel plate 40, there are connected the flow channels 50a, 50b in the circulation mechanism 5 described above so as to achieve inflow of the ink 9 to the flow channel and outflow of the ink 9 from the flow channel, respectively. It should be noted that since it is arranged that the dummy channels C1d, C2d are closed by the bottom part of the cover plate 413 as described above, the ink 9 is supplied only to the ejection channels C1e, C2e, but does not inflow into the dummy channels C1d, C2d.

[Flow Channel Structure Around Ejection Channels C1e, C2e]

Then, the flow channel structure of the ink 9 in a part for communicating the supply slit Sin1, Sin2 and the discharge slit Sout1, Sout2 described above with the ejection channel C1e, C2e will be described in detail with reference to FIG. 4 (a cross-sectional configuration example of the vicinity of the ejection channels C1e, C2e) described above.

As shown in FIG. 4, in the head chip 41 according to the present embodiment, the cover plate 413 is provided with the supply slits Sin1, Sin2, the discharge slits Sout1, Sout2, and wall parts W1, W2. Specifically, the supply slits Sin1 and the discharge slits Sout1 are each a through hole through which the ink 9 flows to or from the ejection channel C1e, and the supply slits Sin2 and the discharge slits Sout2 are each a through hole through which the ink 9 flows to or from the ejection channel C2e. In detail, as indicated by the dotted arrows in FIG. 4, the supply slits Sin1, Sin2 are through holes for making the ink 9 inflow into the ejection channels C1e, C2e, respectively, and the discharge slits Sout1, Sout2 are through holes for making the ink 9 outflow from the inside of the ejection channels C1e, C2e, respectively.

Further, the wall part W1 described above is disposed between the entrance side common ink chamber Rin1 and the exit side common ink chamber Rout1 so as to cover above the ejection channels C1e. Similarly, the wall part W2 described above is disposed between the entrance side common ink chamber Rin2 and the exit side common ink chamber Rout2 so as to cover above the ejection channels C2e.

[Configuration of Individual Interconnections Wda, Common Interconnections Wdc, and Common Electrodes Edc2]

Then, the interconnections (the individual interconnections Wda, the common interconnections Wdc and the common electrodes Edc2) will be described with reference to FIG. 4 through FIG. 7.

As shown in FIG. 4 and FIG. 7, in an area corresponding to the periphery of the groove section S0 of the actuator plate 412 in the bottom surface of the cover plate 413, the common electrodes Edc2 for electrically connecting the plurality of common electrodes Edc located in the same channel column 421 (or the same channel column 422) on the actuator plate 412 side to each other are formed so as to extend in the X-axis direction. Thus, the plurality of common electrodes Edc is electrically connected to each other in the X-axis direction and is commonalized on the cover plate 413 side.

As shown in FIG. 4 and FIG. 7, the common electrodes Edc2 are also formed inside the supply slits Sin1, Sin2. Further, as shown in FIG. 5, the common electrodes Edc2 are also formed inside the exit side common ink chambers Rout1, Rout2, and the entrance side common ink chambers Rin1, Rin2.

Further, as shown in FIG. 7, on both end parts in the X-axis direction of the bottom surface of the cover plate 413, there are formed the common interconnections Wdc. Further, as shown in FIG. 7, on both end parts in the Y-axis direction of the bottom surface of the cover plate 413, there are formed the individual interconnections Wda. It should be noted that in FIG. 7, there are shown the common interconnections Wdc only on one end part side in the X-axis direction as the common interconnections Wdc. The common interconnections Wdc are formed in respective areas corresponding to the two channel columns 421, 422 (see FIG. 6). The common interconnection Wdc located in the area corresponding to the channel column 421 electrically connects the plurality of common electrodes Edc located in the channel column 421 and the FPC 441 located on the channel column 421 side to each other via the common electrodes Edc2. Similarly, the common interconnection Wdc located in the area corresponding to the channel column 422 electrically connects the plurality of common electrodes Edc located in the channel column 422 and the FPC 442 located on the channel column 422 side to each other via the common electrodes Edc2. In contrast, the individual interconnections Wda each electrically connect the pair of individual electrodes Eda opposed to each other via the ejection channel C1e (or the ejection channel C2e) to the FPC 441 (or the FPC 442).

[Configuration of Alignment Marks 501, 502 and Predetermined Marks]

Then, the details of the configuration of the formation positions and so on of the alignment marks 501, 502 and the predetermined marks formed on the bonding surface 471 with the nozzle plate 411 in the actuator plate 412 will be described with reference mainly to FIG. 8 and FIG. 9. The alignment marks 501, 502 are marks for the alignment between the actuator plate 412 and the nozzle plate 411.

In the actuator plate 412, on the bonding surface 471 with the nozzle plate 411, there are formed the predetermined marks with which the position of the nozzle plate 411 with respect to the actuator plate 412 can be checked. In FIG. 2 and FIG. 8, there are formed the first through third position checking marks 511, 512, 513, and the other first through third position checking marks 521, 522, 523 as the predetermined marks.

The profile of the bonding surface 471 of the actuator nozzle 412 with the nozzle plate 411 is made larger than the profile of the nozzle plate 411. As shown in FIG. 8, the predetermined marks are formed in an area outside the part corresponding to the outer periphery of the nozzle plate 411 in the bonding surface 471 of the actuator plate 412 with the nozzle plate 411. It should be noted that the area provided with a pattern (dot pattern) filled with dots is an example of an “area corresponding to the inside of the nozzle plate 411,” and the area outside the area provided with the dot pattern is an example of an “area outside the part corresponding to the outer periphery of the nozzle plate 411” in FIG. 8.

As shown in FIG. 8, the alignment marks 501, 502 are formed in an area corresponding to the inside of the nozzle plate 411 in the bonding surface 471 of the actuator plate 412 with the nozzle plate 411. It should be noted that although there is shown an example of forming the two alignment marks 501, 502 in the actuator plate 412 in FIG. 2 and FIG. 8, it is also possible to provide just one alignment mark. Further, it is also possible to form three or more alignment marks.

As shown in FIG. 8, it is preferable for the predetermined marks to be formed on an extended line of the alignment mark 501, 502 at a distance from the alignment mark 501, 502 in the bonding surface 471 of the actuator plate 412 with the nozzle plate 411.

Further, the alignment marks 501, 502 each have, for example, an X shape having parts respectively extending in four directions. It is preferable for the predetermined marks to be formed on the extended line of at least one direction out of the four directions in which each of the alignment marks 501, 502 extends. It should be noted that in the example shown in FIG. 2 and FIG. 8, the alignment marks 501, 502 are each provided with the X shape due to a first straight part parallel to the X-axis direction, and a second straight part parallel to an oblique direction (the extending direction of the ejection channels C1e, C2e) crossing the X-axis direction. It should be noted that it is also possible to adopt an X shape (a cruciform shape) in which the second straight part is parallel to the Y-axis direction, and the first straight part and the second straight part are perpendicular to each other. It should be noted that the shape of each of the alignment marks 501, 502 is not limited to the X shape, but can also be other shapes.

For example, as shown in FIG. 8, it is preferable for the position checking marks (the first through third position checking marks 511, 512, 513) to respectively be formed on the three extended lines of the alignment mark 501 out of the four directions in which the alignment mark 501 extends. Further, it is preferable for the other position checking marks (the other first through third position checking marks 521, 522, 523) to respectively be formed on the three extended lines of the other alignment mark 502 out of the four directions in which the other alignment mark 502 extends.

It is preferable for the alignment marks 501, 502 and the predetermined marks to be formed so as to have a groove shape.

It is also possible for the inkjet head 4 to be further provided with a cover member for covering at least the actuator plate 412 from an opposite surface side to the bonding surface 471 in the nozzle plate 411 with the actuator plate 412. For example, as shown in FIG. 9, it is also possible to provide a nozzle guard 530 for covering the nozzle plate 411 and the actuator plate 412 as the cover member. It is also possible to arrange to cover the predetermined marks with the cover member such as the nozzle guard 530. The nozzle guard 530 is provided with openings 541, 542 corresponding respectively to the nozzle columns An1, An2 described above.

[Bonding Process of Actuator Plate 412 and Nozzle Plate 411]

Then, a process of bonding the actuator plate 412 and the nozzle plate 411 to each other while aligning the actuator plate 412 and the nozzle plate 411 with each other using the alignment marks 501, 502 described above will be described.

Firstly, an adhesive is applied on the bonding surface 471 of the actuator plate 412. Then, using arbitrary one of the plurality of nozzle holes H1, H2 of the nozzle plate 411 as a reference nozzle hole, the positions in the X-Y plane of the alignment marks 501, 502 with respect to the reference nozzle hole are recognized. It should be noted that it is also possible to reverse the order of the processes described above. Specifically, it is also possible to perform the process of applying the adhesive after performing the process of recognizing the positions of the alignment marks 501, 502.

Then, the nozzle plate 411 is translated so that the reference nozzle hole and the alignment marks 501, 502 are located at a predetermined relative position (a correct bonding position). Then, the nozzle plate 411 is moved vertically in the Z-axis direction to bond the nozzle plate 411 to the bonding surface 471 of the actuator plate 412.

[Operations and Functions/Advantages]

(A. Basic Operation of Printer 1)

In the printer 1, a recording operation (a printing operation) of images, characters, and so on to the recording paper P is performed in the following manner. It should be noted that as an initial state, it is assumed that the four types of ink tanks 3 (3Y, 3M, 3C, and 3B) shown in FIG. 1 are sufficiently filled with the ink 9 of the corresponding colors (the four colors), respectively. Further, there is achieved the state in which the inkjet heads 4 are filled with the ink 9 in the ink tanks 3 via the circulation mechanism 5, respectively.

In such an initial state, when operating the printer 1, the grit rollers 21 in the carrying mechanisms 2a, 2b rotate to thereby carry the recording paper P along the carrying direction d (the X-axis direction) between the grit rollers 21 and the pinch rollers 22. Further, at the same time as such a carrying operation, the drive motor 633 in the drive mechanism 63 respectively rotates the pulleys 631a, 631b to thereby operate the endless belt 632. Thus, the carriage 62 reciprocates along the width direction (the Y-axis direction) of the recording paper P while being guided by the guide rails 61a, 61b. Then, on this occasion, the four colors of ink 9 are appropriately ejected on the recording paper P by the respective inkjet heads 4 (4Y, 4M, 4C, and 4B) to thereby perform the recording operation of images, characters, and so on to the recording paper P.

(B. Detailed Operation in Inkjet Heads 4)

Then, the detailed operation (the jet operation of the ink 9) in the inkjet heads 4 will be described with reference to FIG. 1 through FIG. 5. Specifically, in the inkjet heads 4 (the side-shoot type) according to the present embodiment, the jet operation of the ink 9 using a shear mode is performed in the following manner.

Firstly, when the reciprocation of the carriage 62 (see FIG. 1) described above is started, the drive circuit on the circuit board described above applies the drive voltage to the drive electrodes Ed (the common electrodes Edc and the individual electrodes Eda) in the inkjet head 4 via the flexible printed circuit boards described above. Specifically, the drive circuit applies the drive voltage to the individual electrodes Eda disposed on the pair of drive walls Wd forming the ejection channel C1e, C2e. Thus, the pair of drive walls Wd each deform (see FIG. 3) so as to protrude toward the dummy channel C1d, C2d adjacent to the ejection channel C1e, C2e.

Here, as described above, in the actuator plate 412, the polarization direction differs along the thickness direction (the two piezoelectric substrates described above are stacked on one another), and at the same time, the drive electrodes Ed are formed in the entire area in the depth direction on the inner side surface in each of the drive walls Wd. Therefore, by applying the drive voltage using the drive circuit described above, it results that the drive wall Wd makes a flexion deformation to have a V shape centered on the intermediate position in the depth direction in the drive wall Wd. Further, due to such a flexion deformation of the drive wall Wd, the ejection channel C1e, C2e deforms as if the ejection channel C1e, C2e bulges. Incidentally, in the case in which the configuration of the actuator plate 412 is not the chevron type but is the cantilever type described above, the drive wall Wd makes the flexion deformation to have the V shape in the following manner. That is, in the case of the cantilever type, since it results that the drive electrode Ed is attached by the oblique evaporation to an upper half in the depth direction, by the drive force exerted only on the part provided with the drive electrode Ed, the drive wall Wd makes the flexion deformation (in the end part in the depth direction of the drive electrode Ed). As a result, even in this case, since the drive wall Wd makes the flexion deformation to have the V shape, it results that the ejection channel C1e, C2e deforms as if the ejection channel C1e, C2e bulges.

As described above, due to the flexion deformation caused by a piezoelectric thickness-shear effect in the pair of drive walls Wd, the capacity of the ejection channel C1e, C2e increases. Further, due to the increase of the capacity of the ejection channel C1e, C2e, it results that the ink 9 retained in the entrance side common ink chamber Rin1, Rin2 is induced into the ejection channel C1e, C2e (see FIG. 4).

Subsequently, the ink 9 having been induced into the ejection channel C1e, C2e in such a manner turns to a pressure wave to propagate to the inside of the ejection channel C1e, C2e. Then, the drive voltage to be applied to the drive electrodes Ed becomes 0 (zero) V at the timing at which the pressure wave has reached the nozzle hole H1, H2 of the nozzle plate 411. Thus, the drive walls Wd are restored from the state of the flexion deformation described above, and as a result, the capacity of the ejection channel C1e, C2e having once increased is restored again (see FIG. 3).

When the capacity of the ejection channel C1e, C2e is restored in such a manner, the internal pressure of the ejection channel C1e, C2e increases, and the ink 9 in the ejection channel C1e, C2e is pressurized. As a result, the ink 9 having a droplet shape is ejected (see FIG. 3 and FIG. 4) toward the outside (toward the recording paper P) through the nozzle hole H1, H2. The jet operation (the ejection operation) of the ink 9 in the inkjet head 4 is performed in such a manner, and as a result, the recording operation of images, characters, and so on to the recording paper P is performed.

In particular, the nozzle holes H1, H2 of the present embodiment each have the tapered cross-sectional shape gradually decreasing in diameter toward the outlet (see FIG. 3 and FIG. 4) as described above, and can therefore eject the ink 9 straight (good in straightness) at high speed. Therefore, it becomes possible to perform recording high in image quality.

(C. Circulation Operation of Ink 9)

Then, the circulation operation of the ink 9 by the circulation mechanism 5 will be described in detail with reference to FIG. 1 and FIG. 4.

As shown in FIG. 1, in the printer 1, the ink 9 is fed by the liquid feeding pump 52a from the inside of the ink tank 3 to the inside of the flow channel 50a. Further, the ink 9 flowing through the flow channel 50b is fed by the liquid feeding pump 52b to the inside of the ink tanks 3.

On this occasion, in the inkjet head 4, the ink 9 flowing from the inside of the ink tank 3 via the flow channel 50a inflows into the entrance side common ink chambers Rin1, Rin2. As shown in FIG. 4, the ink 9 having been supplied to these entrance side common ink chambers Rin1, Rin2 is supplied to the ejection channels C1e, C2e in the actuator plate 412 via the supply slits Sin1, Sin2.

Further, as shown in FIG. 4, the ink 9 in the ejection channels C1e, C2e flows into the exit side common ink chambers Rout1, Rout2 via the discharge slits Sout1, Sout2, respectively. The ink 9 having been supplied to these exit side common ink chambers Rout1, Rout2 is discharged to the flow channel 50b to thereby outflow from the inkjet head 4. Then, the ink 9 having been discharged to the flow channel 50b is returned to the inside of the ink tank 3 as a result. In such a manner, the circulation operation of the ink 9 by the circulation mechanism 5 is achieved.

Here, in the inkjet head which is not the circulation type, in the case in which ink of a fast drying type is used, there is a possibility that a local increase in viscosity or local solidification of the ink occurs due to drying of the ink in the vicinity of the nozzle hole, and as a result, a failure such as an ink ejection failure occurs. In contrast, in the inkjet heads 4 (the circulation type inkjet heads) according to the present embodiment, since the fresh ink 9 is always supplied to the vicinity of the nozzle holes H1, H2, the failure such as the failure in ejection of the ink described above is prevented as a result.

(D. Functions/Advantages)

Then, the functions and the advantages in the head chip 41, the inkjet head 4 and the printer 1 according to the present embodiment will be described in detail while comparing with a comparative example.

### Comparative Example

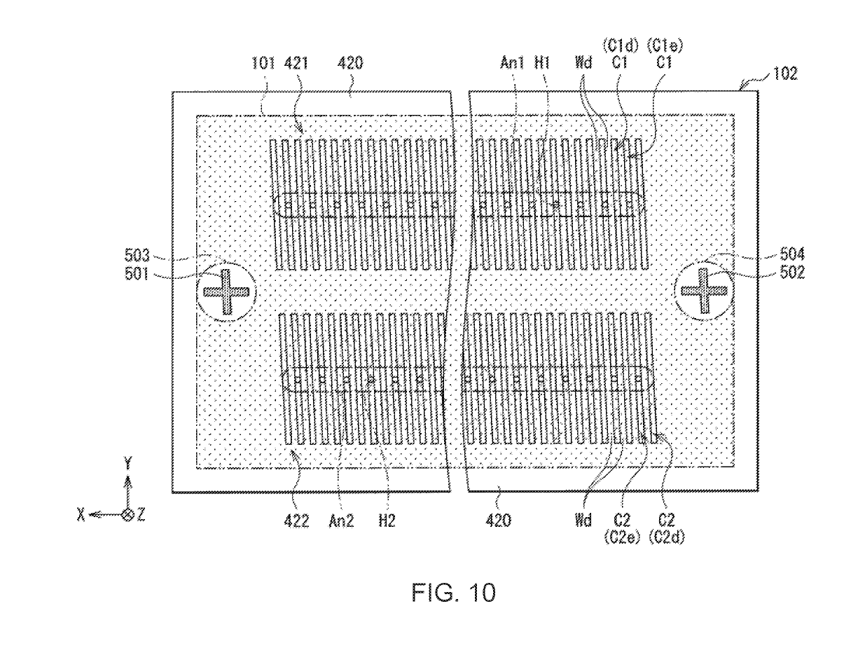

FIG. 10 is a bottom view schematically showing a configuration example of a substantial part of an inkjet head related to a comparative example. The inkjet head related to the comparative example is provided with a nozzle plate 101 and an actuator plate 102 instead of the nozzle plate 411 and the actuator plate 412 in the inkjet head 4 according to the present embodiment shown in FIG. 2 and FIG. 8. The actuator plate 412 in the inkjet head 4 according to the present embodiment is provided with the alignment marks 501, 502 and the predetermined marks (the first through third position checking marks 511, 512, 513, and the other first through third position checking marks 521, 522, 523) described above as shown in FIG. 2 and FIG. 8. In contrast, the actuator plate 102 in the inkjet head of the comparative example is provided with the alignment marks 501, 502, but is not provided with the predetermined marks. Further, in the actuator plate 102 in the inkjet head of the comparative example, checking windows 503, 504 for checking the bonding position between the nozzle plate 101 and the actuator plate 102 are disposed at positions corresponding to the alignment marks 501, 502 in the nozzle plate 101. It should be noted that the actuator plate 412 in the inkjet head 4 according to the present embodiment is not provided with such checking windows 503, 504.

As described above, in the inkjet head of the comparative example, there are provided the checking windows 503, 504 for checking the bonding position between the nozzle plate 101 and the actuator plate 102. However, if the checking windows 503, 504 are provided to the nozzle plate 101 itself, there is a concern that the ink is accumulated in the checking windows 503, 504 while in use, and then drops on the recording target medium. Therefore, in the inkjet head the comparative example, the reliability is damaged as a result.

### Present Embodiment

In contrast, in the inkjet head 4 according to the present embodiment, on the bonding surface 471 of the actuator plate 412 with the nozzle plate 411, there are formed the predetermined marks (the first through third position checking marks 511, 512, 513, and the other first through third position checking marks 521, 522, 523) in the area outside the part corresponding to the outer periphery of the nozzle plate 411 as shown in FIG. 8. Thus, it becomes possible to check the bonding position of the nozzle plate 411 even after bonding the nozzle plate 411 to the actuator plate 412. For example, even in the case in which the nozzle plate 411 is formed of an opaque material, it becomes possible to check the bonding position without providing the checking windows (the checking windows 503, 504) to the nozzle plate 411 itself as in the comparative example shown in FIG. 10. Thus, the positioning accuracy in bonding the nozzle plate 411 to the actuator plate 412 is improved, and it is possible to raise the fabrication yield. If the checking window is opened in the nozzle plate 411 itself, there is a concern that the ink is accumulated in the window part, and drops on the recording target medium. In the present embodiment, since the part in which the ink is accumulated is fewer compared to the case of providing the checking windows to the nozzle plate 411 itself as in the comparative example described above, it is possible to enhance the reliability of the inkjet head 4.

Further, in the inkjet head 4 according to the present embodiment, the alignment marks 501, 502 are formed in an area corresponding to the inside of the nozzle plate 411 in the bonding surface 471 of the actuator plate 412 with the nozzle plate 411 as shown in FIG. 8. Thus, it is possible to check the position of the nozzle plate 411 with respect to the actuator plate 412 using the predetermined marks after positioning the nozzle plate 411 with respect to the actuator plate 412 using the alignment marks 501, 502. For example, checking of the position with the predetermined marks can be achieved using the relative position of the nozzle plate 411 to the reference nozzle hole explained in the above description of the bonding process. Further, as another example, it is also possible to provide other marks to the nozzle plate 411 to check the position of the nozzle plate 411 with respect to the actuator plate 412 using the relative position between the other marks and the predetermined marks in the actuator plate 412. Thus, even in the case in which there is no space for forming the alignment marks 501, 502 in the area outside the part corresponding to the outer periphery of the nozzle plate 411 on the bonding surface 471 of the actuator plate 412 with the nozzle plate 411, it is possible to perform the positioning with the alignment marks 501, 502 and the check of the position after the positioning. Since there is no need to form the alignment marks 501, 502 in the outside area described above in the actuator plate 412, it is possible to reduce the area for disposing the alignment marks 501, 502. Thus, it is possible to miniaturize the actuator plate 412, and by extension, the head chip 41. It should be noted that if the actuator plate 412 has an extra space, it is also possible to form the alignment marks 501, 502 in the outside area described above.

Further, in the inkjet head 4 according to the present embodiment, by forming the predetermined marks on the extended lines of each of the alignment marks 501, 502 in the bonding surface 471 of the actuator plate 412 with the nozzle plate 411 as shown in FIG. 8, it becomes easy to check the positioning performed using the alignment marks 501, 502. Further, it becomes easy to accurately form the predetermined marks and the alignment marks 501, 502 with respect to the positions of the ejection channels C1e, C2e in manufacturing.

Further, in the inkjet head 4 according to the present embodiment, by providing the X shape having the parts respectively extending in the four directions to each of the alignment marks 501, 502, and forming the predetermined marks on the extended lines in at least one of the four directions of each of the alignment marks 501, 502 each having the X shape, it becomes easy to check the positioning using the alignment marks 501, 502. Further, it becomes easy to accurately form the predetermined marks and the alignment marks 501, 502 with respect to the positions of the ejection channels C1e, C2e in manufacturing.

Further, in the inkjet head 4 according to the present embodiment, by forming the alignment marks 501, 502 and the predetermined marks so as to have a groove shape, it is possible to form the alignment marks 501, 502 and the predetermined marks at the same time as the formation of the grooves of the ejection channels C1e, C2e. Thus, it is possible to easily form the alignment marks 501, 502 and the predetermined marks in manufacturing.

Further, in the inkjet head 4 according to the present embodiment, at least a part of the groove shape of the predetermined marks is formed in parallel to the ejection channels C1e, C2e. Thus, in the case of using a cutting tool such as a dicer when performing cutting work on the ejection channels C1e, C2e, it is possible to form the predetermined marks at the same time as the formation of the ejection channels C1e, C2e while keeping the cutting direction of the tool fixed, and therefore, it is possible to accurately form the predetermined marks.

Further, in the inkjet head 4 according to the present embodiment, as shown in FIG. 9, since it is arranged that the nozzle guard 530 for covering the nozzle plate 411 and the actuator plate 412 is provided as the cover member, it is possible to conceal the predetermined marks with the nozzle guard 530 as the cover member. Thus, the liquid is prevented from being accumulated in the predetermined marks while in use, and the possibility that the liquid drops on the recording target medium is reduced. Further, since the predetermined marks are invisible to the user, the appearance of the inkjet head 4 is also improved.

### 2. MODIFIED EXAMPLES

Then, some modified examples (Modified Examples 1 through 3) of the embodiment described above will be described. It should be noted that the same constituents as those in the embodiment are denoted by the same reference symbols, and the description thereof will arbitrarily be omitted.

### Modified Example 1

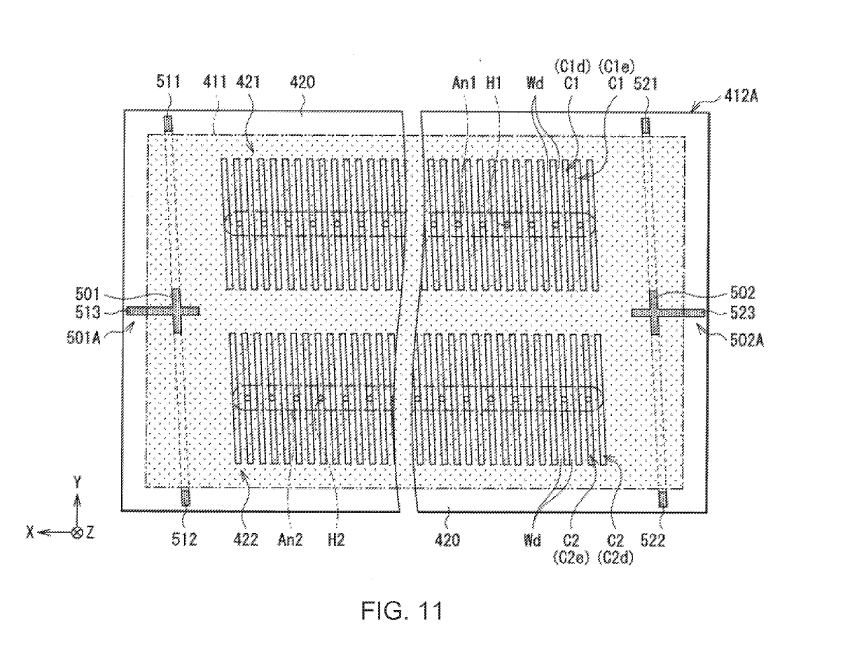

FIG. 11 is a bottom view schematically showing a configuration example of a substantial part of an inkjet head (an actuator plate 412A) related to Modified Example 1. The inkjet head (the actuator plate 412A) of Modified Example 1 corresponds to what is obtained by changing the structure of the vicinity of the alignment marks 501, 502 in the inkjet head 4 (the actuator plate 412) of the embodiment shown in FIG. 2 and FIG. 8, and the rest of the configuration is made basically the same.

Specifically, in the inkjet head 4 according to the embodiment, the alignment marks 501, 502 and the predetermined marks (the first through third position checking marks 511, 512, 513, and the other first through third position checking marks 521, 522, 523) are formed at a distance from each other to form the configuration in which the alignment marks 501, 502 and all of the predetermined marks are separated from each other as shown in FIG. 2 and FIG. 8. In contrast, in the inkjet head (FIG. 11) of Modified Example 1, some of the predetermined marks are formed of a part 501A, 502A of the alignment mark extending from the alignment mark 501, 502. Specifically, the third position checking mark 513 is formed of the part 501A of the alignment mark partially extending from the alignment mark 501. Further, the other third position checking mark 523 is formed of the part 502A of the alignment mark partially extending from the other alignment mark 502. It should be noted that it is also possible to form all of the predetermined marks with respective parts of the alignment marks partially extending from the alignment marks 501, 502.

As describe above, in the inkjet head of Modified Example 1, by forming at least some of the predetermined marks as the parts 501A, 502A extending from the respective alignment marks 501, 502, it becomes easy to check the positioning due to the alignment marks 501, 502. Further, it becomes easy to form the predetermined marks and the alignment marks 501, 502 in manufacturing.

In the inkjet head of Modified Examples 1 having such a configuration, it is also possible to obtain basically the same advantage due to substantially the same function as that of the inkjet head 4 of the embodiment.

### Modified Example 2

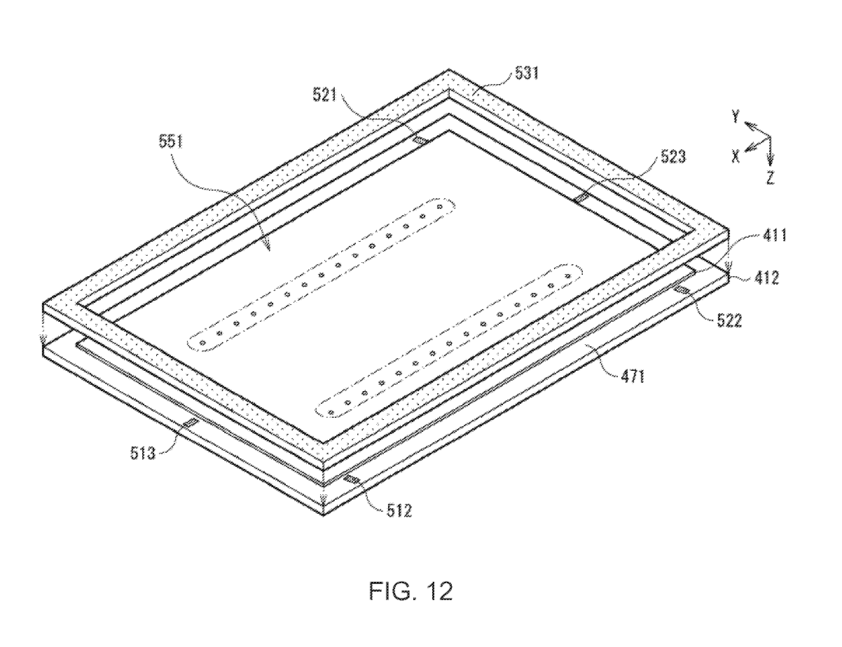

FIG. 12 is an exploded perspective view showing a configuration example of a substantial part of an inkjet head related to Modified Example 2. The inkjet head of Modified Example 2 corresponds to what is obtained by changing the structure of the nozzle guard 530 in the inkjet head 4 of the embodiment shown in FIG. 9, and the rest of the configuration is made basically the same.

Specifically, in the inkjet head 4 according to the embodiment, the nozzle guard 530 for covering the nozzle plate 411 and the actuator plate 412 is provided as the cover member, and the predetermined marks are covered with the nozzle guard 530. In contrast, in the inkjet head (FIG. 12) of Modified Example 2, a cover member 531 is provided instead of the nozzle guard 530. The cover member 531 is arranged to cover the area outside the part corresponding to the outer periphery of the nozzle plate 411 in the actuator plate 412 from the opposite surface side to the bonding surface 471 in the nozzle plate 411 with the actuator plate 412. The cover member 531 is provided with an opening 551 in an area corresponding to the inside of the nozzle plate 411.

It is possible to conceal the predetermined marks with such a cover member 531. Thus, the liquid is prevented from being accumulated in the predetermined marks while in use, and the possibility that the liquid drops on the recording target medium is reduced. Further, since the predetermined marks are invisible to the user, the appearance of the inkjet head 4 is also improved.

In the inkjet head of Modified Examples 2 having such a configuration, it is also possible to obtain basically the same advantage due to substantially the same function as that of the inkjet head 4 of the embodiment.

### Modified Example 3

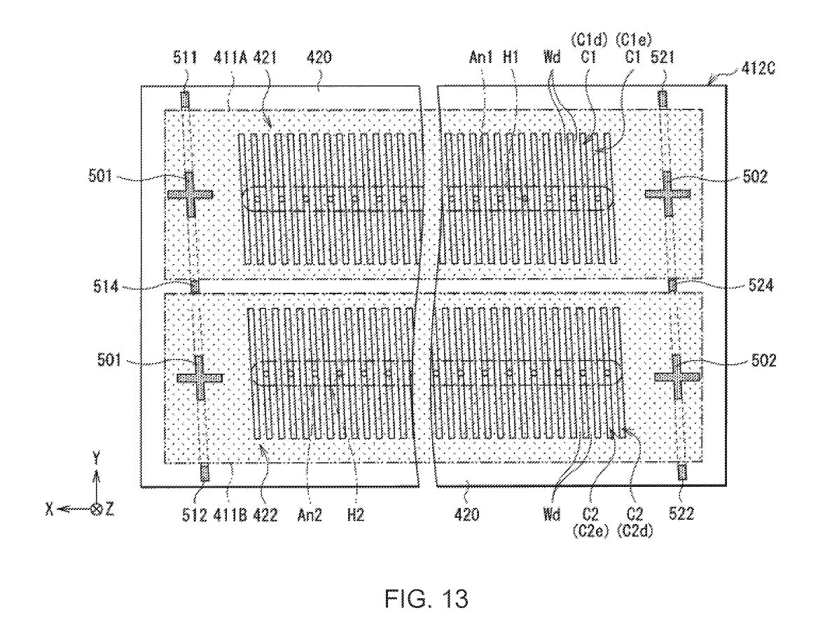

FIG. 13 is a bottom view schematically showing a configuration example of a substantial part of an inkjet head (nozzle plates 411A, 411B, and an actuator plate 412C) related to Modified Example 3. The inkjet head of Modified Example 3 corresponds to what is obtained by changing the structure of the nozzle plate 411, and the structure of the vicinity of the alignment marks 501, 502 and the predetermined marks in the inkjet head 4 (the nozzle plate 411 and the actuator plate 412) of the embodiment shown in FIG. 2 and FIG. 8, and the rest of the configuration is made basically the same.

The inkjet head of Modified Example 3 is provided with the nozzle plates 411A, 411B divided into two instead of the nozzle plate 411 in the inkjet head 4 according to the embodiment. One nozzle plate 411A is provided with one nozzle column An1 extending along the X-axis direction. The other nozzle plate 411B is provided with the other nozzle column An2 extending along the X-axis direction.

The one nozzle plate 411A and the other nozzle plate 411B are disposed in parallel to each other in the Y-axis direction on the lower surface (the bonding surface 471) of the actuator plate 412C. The one nozzle plate 411A and the other nozzle plate 411B are disposed in parallel to each other at a predetermined distance in a roughly central part in the Y-axis direction.

It is also possible to form the alignment marks and the predetermined marks in substantially the same manner as in the inkjet head 4 according to the embodiment in each of the nozzle plates 411A, 411B divided into two as described above. In this case, it is also possible to form the predetermined marks in the roughly central part between the one nozzle plate 411A and the other nozzle plate 411B in the Y-axis direction.

For example, as shown in FIG. 13, it is also possible to form the predetermined marks (the first position checking mark 511 and the third position checking mark 514, and the other first position checking mark 521 and the other third position checking mark 524) in the area outside the part corresponding to the outer periphery of the nozzle plate 411A on the bonding surface 471 of the actuator plate 412C with the nozzle plate 411A. Further, it is also possible to form the predetermined marks (the second position checking mark 512 and the third position checking mark 514, and the other second position checking mark 522 and the other third position checking mark 524) in the area outside the part corresponding to the outer periphery of the nozzle plate 411B on the bonding surface 471 of the actuator plate 412C with the nozzle plate 411B.

Further, for example, as shown in FIG. 13, it is also possible to form the alignment marks 501, 502 in the area corresponding to the inside of each of the nozzle plates 411A, 411B.

It should be noted that the area provided with the dot pattern is an example of an “area corresponding to the inside of the nozzle plate 411A, 411B,” and the area outside the area provided with the dot pattern is an example of an “area outside the part corresponding to the outer periphery of the nozzle plate 411A, 411B” in FIG. 13.

In the inkjet head of Modified Examples 3 having such a configuration, it is also possible to obtain basically the same advantage due to substantially the same function as that of the inkjet head 4 of the embodiment.

### 3. OTHER MODIFIED EXAMPLES

The present disclosure is described hereinabove citing the embodiment and some modified examples, but the present disclosure is not limited to the embodiment and so on, and a variety of modifications can be adopted.

For example, in the embodiment described above, the description is presented specifically citing the configuration examples (the shapes, the arrangements, the number and so on) of each of the members in the printer, the inkjet head and the head chip, but those described in the above embodiment and so on are not limitations, and it is possible to adopt other shapes, arrangements, numbers and so on. Further, the values or the ranges, the magnitude relation and so on of a variety of parameters described in the above embodiment and so on are not limited to those described in the above embodiment and so on, but can also be other values or ranges, other magnitude relation and so on.

Specifically, for example, in the embodiment described above, the description is presented citing the inkjet head 4 of the two column type (having the two nozzle columns An1, An2), but the example is not a limitation. Specifically, for example, it is also possible to adopt an inkjet head of a single column type (having a single nozzle column), or an inkjet head of a multi-column type (having three or more nozzle columns) with three or more columns (e.g., three columns or four columns).

Further, for example, in the embodiment described above and so on, there is described the case in which the ejection channels (the ejection grooves) and the dummy channels (the non-ejection grooves) each extend along the oblique direction in the actuator plate 412, but this example is not a limitation. Specifically, it is also possible to arrange that, for example, the ejection channels and the dummy channels extend along the Y-axis direction in the actuator plate 412.

Further, for example, the cross-sectional shape of each of the nozzle holes H1, H2 is not limited to the circular shape as described in the above embodiment and so on, but can also be, for example, an elliptical shape, a polygonal shape such as a triangular shape, or a star shape.

In addition, in the embodiment and so on described above, the example of the so-called side-shoot type inkjet head for ejecting the ink 9 from the central part in the extending direction (the oblique direction described above) of the ejection channels C1e, C2e is described, but the example is not a limitation. Specifically, it is also possible to apply the present disclosure to a so-called edge-shoot type inkjet head for ejecting the ink 9 along the extending direction of the ejection channels C1e, C2e.

Further, in the embodiment described above, the description is presented citing the circulation type inkjet head for using the ink 9 while circulating the ink 9 mainly between the ink tank and the inkjet head as an example, but the example is not a limitation. Specifically, it is also possible to apply the present disclosure to a non-circulation type inkjet head using the ink 9 without circulating the ink 9.

Further, the series of processes described in the above embodiment and so on can be arranged to be performed by hardware (a circuit), or can also be arranged to be performed by software (a program). In the case of arranging that the series of processes is performed by the software, the software is constituted by a program group for making the computer perform the functions. The programs can be incorporated in advance in the computer described above, and are then used, or can also be installed in the computer described above from a network or a recording medium and are then used.

In addition, in the above embodiment, the description is presented citing the printer 1 (the inkjet printer) as a specific example of the “liquid jet recording device” in the present disclosure, but this example is not a limitation, and it is also possible to apply the present disclosure to other devices than the inkjet printer. In other words, it is also possible to arrange that the “head chip” and the “liquid jet head” (the inkjet heads) of the present disclosure are applied to other devices than the inkjet printer. Specifically, for example, it is also possible to arrange that the “head chip” and the “liquid jet head” of the present disclosure are applied to a device such as a facsimile or an on-demand printer.

In addition, it is also possible to apply the variety of examples described hereinabove in arbitrary combination.

It should be noted that the advantages described in the specification are illustrative only but are not a limitation, and another advantage can also be provided.

Further, the present disclosure can also take the following configurations.

<1>

A liquid jet head adapted to jet liquid comprising: an actuator plate having a plurality of ejection grooves each filled with the liquid; and a nozzle plate having a plurality of nozzle holes individually communicated with the respective ejection grooves, formed so as to have a profile smaller than a profile of the actuator plate, and bonded to the actuator plate so as to cover the plurality of ejection grooves, wherein a predetermined mark with which a position of the nozzle plate with respect to the actuator plate is checked is formed in an area outside a part corresponding to an outer periphery of the nozzle plate on a bonding surface of the actuator plate with the nozzle plate.

<2>

The liquid jet head according to <1>, wherein an alignment mark with which positioning of the nozzle plate with respect to the actuator plate is performed is formed in at least an area corresponding to an inside of the nozzle plate on the bonding surface of the actuator plate with the nozzle plate.

<3>

The liquid jet head according to <2>, wherein the predetermined mark is formed on an extended line of the alignment mark at a distance from the alignment mark on the bonding surface of the actuator plate with the nozzle plate.

<4>

The liquid jet head according to <2>, wherein the predetermined mark is formed as a part of the alignment mark extending from the alignment mark on the bonding surface of the actuator plate with the nozzle plate.

<5>

The liquid jet head according to any one of <2> to <4>, wherein the alignment mark has an X shape having parts extending respectively in four directions, and the predetermined mark is formed on an extended line in at least one of the four directions in which the alignment mark extends.

<6>

The liquid jet head according to any one of <1> to <5>, wherein the predetermined mark has a groove shape.

<7>

The liquid jet head according to <6>, wherein at least a part of the groove shape of the predetermined mark is formed in parallel to the plurality of ejection grooves.

<8>

The liquid jet head according to any one of <1> to <7>, further comprising a cover member adapted to cover the actuator plate from the bonding surface side with the nozzle plate, wherein the predetermined mark is covered with the cover member.

<9>

A liquid jet recording device comprising: the liquid jet head according to any one of <1> to <8>; and a containing section adapted to contain the liquid.

What is claimed is:

1. A liquid jet head adapted to jet liquid comprising:
an actuator plate having a plurality of ejection grooves each filled with the liquid; and
a nozzle plate having a plurality of nozzle holes individually communicated with the respective ejection grooves, formed so as to have a profile smaller than a profile of the actuator plate, and bonded to the actuator plate so as to cover the plurality of ejection grooves,
wherein a predetermined mark with which a position of the nozzle plate with respect to the actuator plate is checked is formed in an area outside a part corresponding to an outer periphery of the nozzle plate on a bonding surface of the actuator plate with the nozzle plate.

2. The liquid jet head according to claim 1, wherein
an alignment mark with which positioning of the nozzle plate with respect to the actuator plate is performed is formed in at least an area corresponding to an inside of the nozzle plate on the bonding surface of the actuator plate with the nozzle plate.

3. The liquid jet head according to claim 2, wherein
the predetermined mark is formed on an extended line of the alignment mark at a distance from the alignment mark on the bonding surface of the actuator plate with the nozzle plate.

4. The liquid jet head according to claim 2, wherein
the predetermined mark is formed as a part of the alignment mark extending from the alignment mark on the bonding surface of the actuator plate with the nozzle plate.

5. The liquid jet head according to claim 2, wherein
the alignment mark has an X shape having parts extending respectively in four directions, and the predetermined mark is formed on an extended line in at least one of the four directions in which the alignment mark extends.

6. The liquid jet head according to claim 1, wherein
the predetermined mark has a groove shape.

7. The liquid jet head according to claim 6, wherein
at least a part of the groove shape of the predetermined mark is formed in parallel to the plurality of ejection grooves.

8. The liquid jet head according to claim 1, further comprising a cover member adapted to cover the actuator plate from the bonding surface side with the nozzle plate,
wherein the predetermined mark is covered with the cover member.

9. A liquid jet recording device comprising:
the liquid jet head according to claim 1; and
a containing section adapted to contain the liquid.
